(19) United States
(12) Patent Application Publication
(10) Pub. No.: US 2010/0058199 A1
(43) Pub. Date: Mar. 4, 2010

(54) METHOD AND SYSTEM FOR AUTOMATICALLY RETAINING USER INPUTTED TEXT VALUES

(75) Inventors: Ankush Gera, Fremont, CA (US); Neil Tolani, Hayward, CA (US); Sandeep Sood, Berkeley, CA (US)

Correspondence Address: PERKINS COIE LLP, P.O. BOX 1208, SEATTLE, WA, 98111-1208, US

(73) Assignee: Bottom Line Time Inc., San Francisco, CA (US)

(21) Appl. No.: 12/546,951

(22) Filed: Aug. 25, 2009

Related U.S. Application Data
(60) Provisional application No. 61/092,386, filed on Aug. 27, 2008.

(51) Int. Cl. G06F 3/048; G06F 15/16

(52) U.S. Cl. 715/752

(57) ABSTRACT

A method and system are provided for retaining user-inputted text values. The method includes, responsive to a user command to compose an email in an email client, opening a compose window including a first text input field, wherein the compose window includes a programmer-defined behavior for the first text input field to save a first text input field value. The method includes receiving a user input in the first text input field. The method includes, responsive to detecting the programmer-defined behavior, saving the user input from the first text input field into an accessible memory.

### CROSS REFERENCE TO RELATED APPLICATIONS

This application claims priority to provisional application No. 61/092,386 entitled “Method and System for Automatically Retaining User Inputted Text Value”, filed on Aug. 27, 2008. and which is incorporated herein by reference.

This application is related to provisional application No. 61/035,720 entitled “Method and System for Capturing Billable Time”, filed Mar. 24, 2008, U.S. patent application Ser. No. 12/178,570 entitled “Method and System for Automatically Capturing Billable Time”, filed Jul. 23, 2008, U.S. patent application Ser. No. 12/178,573 entitled “Method and System for Automatically Capturing Billable Time”, filed Jul. 23, 2008, U.S. patent application Ser. No. 12/178,575 entitled “Method and System for Automatically Capturing Billable Time”, filed Jul. 23, 2008, U.S. patent application Ser. No. 12/178,578 entitled “Method and System for Automatically Capturing Billable Time”, filed Jul. 23, 2008, and which are incorporated by reference.

### BACKGROUND

Productivity applications include software such as Microsoft Outlook, a personal information manager including email, calendar, task, contact management, and other functionality. Such applications can be extended by programmer-created applications/plug-ins or otherwise interacting with the Outlook application programming interface (API).

Commonly, programmer-created applications for Outlook and other Microsoft applications utilize “custom forms” in communications with the Outlook API. However, such custom forms appear on a separate pane within an Outlook window. In some cases, this is acceptable, as the programmer-created application provides functionality related to Outlook in general. For example, see www.xobni.com for an email management application; see www.circleup.com for group management, and www.clearcontext.com for another email management application.

It is sometimes desirable to implement a plug-in application directly in an Outlook window. A text input field can be created and placed in an Outlook window as desired. However, for command bars, Microsoft does not support automatic user input capture from such text input fields. Any user input into the text field is only captured and retained when the user presses TAB or ENTER. Any other user input, such as a mouse click anywhere on the window or the screen will cause the user input into the text field to be lost. This is true even for original Microsoft applications, such as the font selection combination box of Microsoft Word.

In one alternative, a menu item can be added to the menu bar providing the desired functionality. However, menu items and selection can be cumbersome for a user.

Thus, there exists a need to automatically capture user inputs into a text input field without requiring the user to press TAB or ENTER.

### BRIEF DESCRIPTION OF THE DRAWINGS

FIG. 1 illustrates an example workstation for automatically capturing user-inputted text values.

FIG. 2A illustrates a first example screen shot of a billing module for automatically capturing user-inputted text values.

FIG. 2B illustrates a second example screen shot of a billing module for automatically capturing user-inputted text values.

FIG. 3 illustrates an example procedure for automatically capturing user-inputted text values.

### DETAILED DESCRIPTION

A method and system for automatically capturing user input in a Microsoft application text input field. A modified input window including the text input field is provided to the user. For example, the modified input window can be a compose email window in Microsoft Outlook. The modified input window can be stored as an Outlook form template. User inputs into the text input field are automatically captured responsive to programmer-defined behavior, such as a mouse click anywhere in a Windows desktop. This protects user inputs in the text input field from loss.

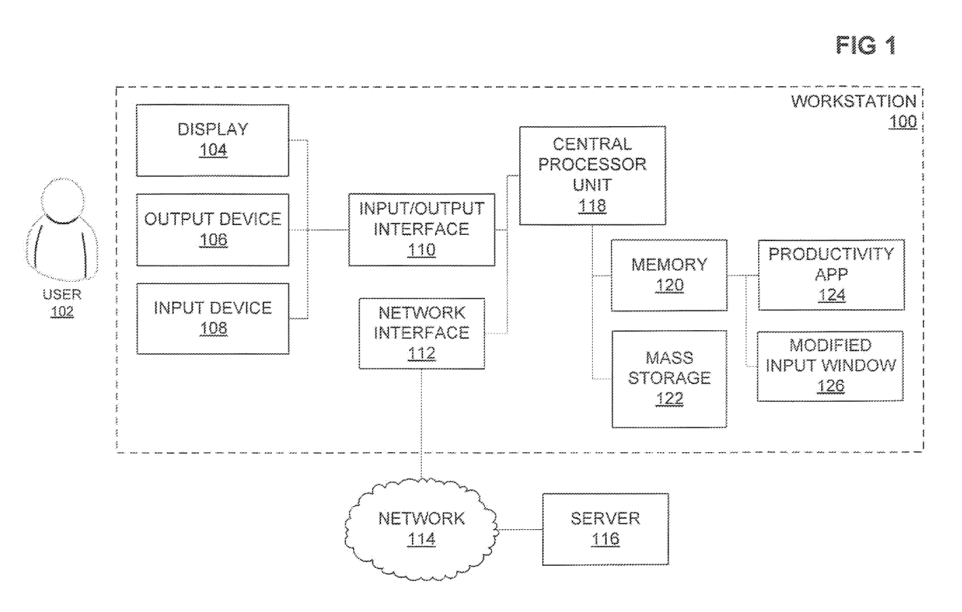

FIG. 1 illustrates an example workstation for automatically capturing user-inputted text values. The workstation 100 call execute various productivity applications and provide a user interface to the productivity applications a user 102. For example, a productivity application can be Microsoft Outlook, including email functionality.

The workstation 100 can be a computing device such as a server, a personal computer, desktop, laptop, a personal digital assistant (PDA) or other computing device. The workstation 100 is accessible to the user 102 and provides a computing platform for various productivity applications.

The workstation 100 can include a display 104. The display 104 can be equipment that displays viewable images generated by the workstation 100. For example, the display 104 can be a cathode ray tube or a flat panel display such as a TFT LCD. The display 104 includes a display surface, circuitry to generate a picture from electronic signals sent by the workstation 100, and an enclosure or case. The display 104 can interface with an input/output interface 110, which converts data to a format compatible with the display 104.

The workstation 100 may include one or more output devices 106. The output device 106 can be any hardware used to communicate outputs to the user. For example, the output device 106 can include speakers and printers, in addition to the display 104 discussed above.

The workstation 100 may include one or more input devices 108. The input device 108 can be any computer hardware used to translate inputs received from the user 102 into data usable by the workstation 100. The input device 108 can include keyboards, mouse pointer devices, microphones, scanners, video and digital cameras, etc.

The workstation 100 includes an input/output interface 110. The input/output interface 110 can include logic and physical ports used to connect and control peripheral devices, such as output devices 106 and input devices 108. For example, the input/output interface 110 can allow input and output devices 106 and 108 to be connected to the workstation 100.

The workstation 100 includes a network interface 112. The network interface 112 includes logic and physical ports used to connect to one or more networks. For example, the network interface 112 can accept a physical network connection and interface between the network and the workstation by translating communications between the two. Example networks can include Ethernet, or other physical network infrastructure. Alternatively, the network interface 112 can be configured to interface with wireless network. Alternatively, the workstation 100 can include multiple network interfaces for interfacing with multiple networks.

The workstation 100 communicates with a network 114 via the network interface 112. The network 114 can be any network configured to carry digital information. For example, the network 114 can be an Ethernet network, the Internet, a wireless network, a cellular data network, or any local Area Network or Wide Area Network.

Alternatively, the workstation 100 can be a client device in communications with a server over the network 114. Thus, the workstation 100 can be configured for lower performance (and thus have a lower hardware cost) and the server provides necessary processing power.

The workstation 100 communicates with a server 116 via the network interlace 112 and the network 114. The server 116 can be computing device providing services to one or more workstations over the network 114.

The workstation 100 includes a central processing unit (CPU) 118. The CPU 118 can be an integrated circuit configured for mass-production and suited for a variety of computing applications. The CPU 118 can sit on a motherboard within the workstation 100 and control other workstation components. The CPU 118 can communicate with the other workstation components via a bus, a physical interchange, or other communication channel.

The workstation 100 includes memory 120. The memory 120 can include volatile and non-volatile memory accessible to the CPU 118. The memory can be random access and provide fast access for graphics-related or other calculations. In an alternative, the CPU 118 can include on-board cache memory for faster performance.

The workstation 100 includes mass storage 122. The mass storage 122 can be volatile or non-volatile storage configured to store large amounts of data. The mass storage 122 can be accessible to the CPU 118 via a bus, a physical interchange, or other communication channel. For example, the mass storage 122 can be a hard drive, a RAID array, flash memory, CD-ROMs, DVDs, HD-DVD or Blu-Ray mediums.

The workstation 100 includes a productivity application 124. For example, the productivity application 124 can be Microsoft Outlook, as discussed above.

The workstation 100 includes a modified input window 126. For example, the modified input window 126 can be a modified compose email window saved as an Outlook form template with an extension of “*.oft”. The modified compose email window can include saving user input responsive to a programmer-defined behavior, such as a mouse click.

In operation, the workstation 100 executes the productivity application 124 and provides a user interface for the user 102. The user 102 can choose to input text into the modified input window 126. Responsive to a user input that is not text input into a text field, the workstation 100 automatically saves the user's text input in the modified input window 126.

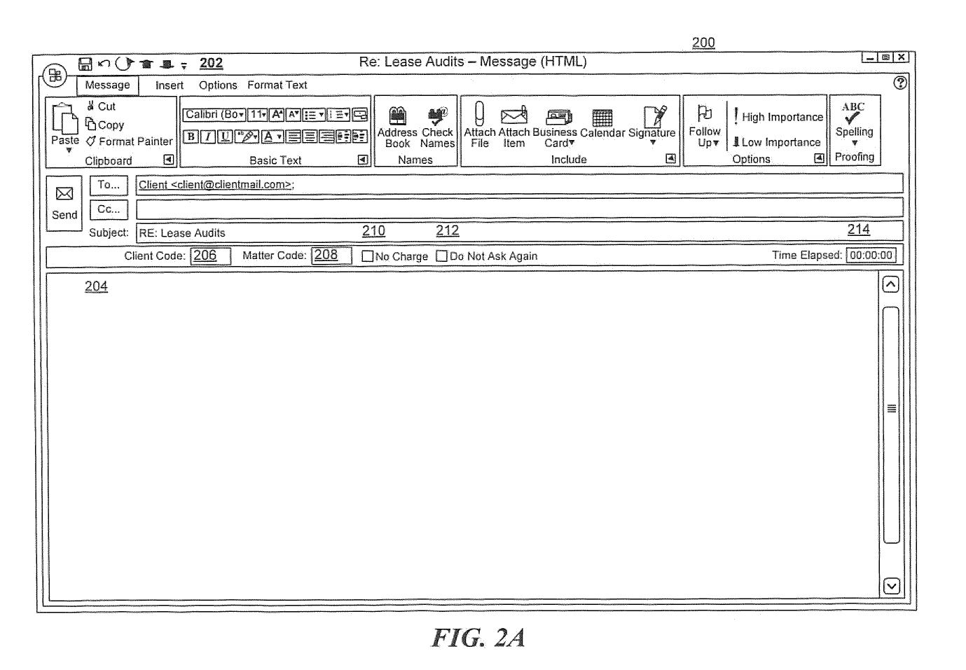

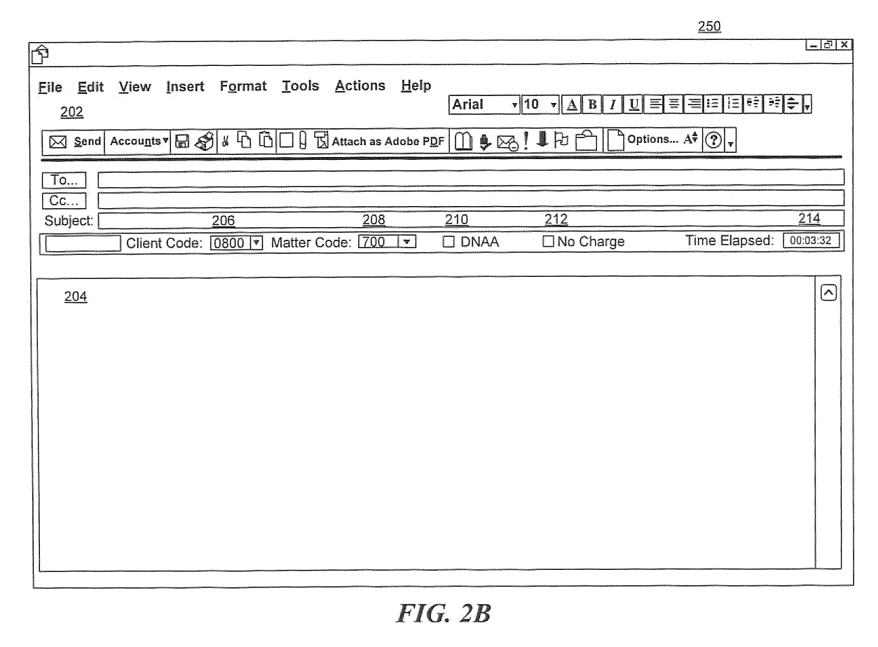

FIG. 2A illustrates a first example screen shot 250 of a billing module for automatically capturing user-inputted text values. The billing module can be integrated into an email client 202 as a plug-in to capture billable time spent on drafting emails. The email client 202 provides email functionality to a user.

As an email client plug-in, the billing module can provide billable time capture functionality whenever the user composes an email, for example, a new email or a reply email. The billing module can detect a first addressee from the “to” field.

The email client 202 includes various menus and tools to provide email and related functionality. Example functionality can include address book, attachment management, contacts management, spell check, etc.

The email client includes an email composition area 204. The email composition area 204 can be a text area where a user inputs in an email body, for example, by typing or utilizing a voice recognition software application. For example, the email composition area 204 can support formatting and other composition features.

The billing module can include a client code input area 206. The client code input area 206 receives a client identifier associated with a specific client within a billing system.

For example, the client code input area 206 can support auto-complete, in which a quantity of possible client codes are displayed responsive to each user-inputted character.

In an alternative example, the client code input area 206 can be a drop-down box automatically populated by a billing manager. For example, an address in the “to” field can be associated with a specific client code. For example, a specific word or phrase, in the “subject” field can be associated with a specific client code. For example, a client code can be embedded in an email body, to which the user is drafting a reply.

In an alternative example, the client code input area 206 can be a combination box, in which the user can enter values but can also select from a drop-down box.

The billing module can include a matter code input area 208. The matter code input area 208 receives a matter identifier associated with a specific matter within a billing system. As discussed above, the matter code can be inputted by the user, auto-filled or auto-completed by the billing module.

For example, the client code input area 206 and matter code input area 208 can be text fields, drop-down menus, or any other GUI input widget. Additional input areas can be used, for example, to receive an activity code or other billing information. The billing module can provide a search engine allowing the user to search for correct billing information.

The billing module can include a “no charge” selection box 210. The “no charge” selection box 210, if selected by the user, indicates the time spent on the email is not to be charged.

The billing module can include a “do not ask again” selection box 212. The “do not ask again” selection box 212, if selected by the user, indicates that emails sent to the email addressee should never be billed in the future. It will be appreciated that the user can negate a designation of an email address as a “do not ask again” via the billing module.

The billing module can include an elapsed time display box 214. The elapsed time display box 214 displays an elapsed time of a timer started when the email draft was created. In one embodiment, the elapsed time display box 214 can be hidden, for example, to prevent distracting the user. In one embodiment, the timer can pause when the email client is minimized, so that only time spent drafting the email is captured.

The billing module inputs discussed above can be hidden responsive to a user input.

The email client can be a modified input window created as an Outlook form template, which allows programmer-specified actions responsive to programmer-specified behavior. An Outlook form template also allows programmer-defined input areas, as discussed above. The programmer-specified actions can include saving values in the client code input area 206 and the matter code input area 208 responsive to mouse clicks anywhere in the modified input window or within the Windows operating system desktop. This allows any user input already in the input areas to be saved.

FIG. 2B illustrates a second example screen shot 250 of a billing module for automatically capturing user-inputted text values. FIG. 2B is similar to FIG. 2A and includes a billing module integrated into an email client 202 as a plug-in. The email client includes an email composition area 204. The billing module can include a client code input area 206, a matter code input area 208, a “no charge” selection box 210, a “do not ask again” selection box 212, and an elapsed time display box 214.

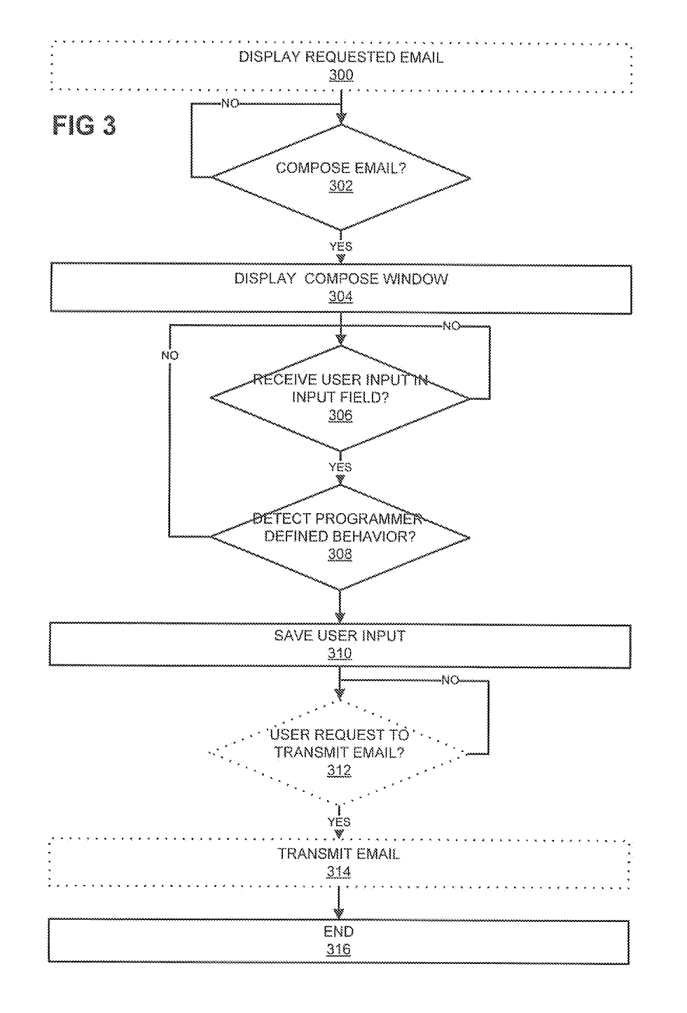

FIG. 3 illustrates an example procedure for automatically capturing user-inputted text values. The procedure can be executed by a modified input form including a text input field. The modified input form can be part of a productivity application executing on a workstation as illustrated in FIG. 1. In one example, the productivity application can be Microsoft Outlook and the modified input form can be a compose email window, as illustrated in FIGS. 2A and 2B.

It will be appreciated that a registry entry pointing to a default compose window can be modified to point to the modified input form to ensure the modified input form is loaded by Outlook when an email is to be composed.

In 300, the modified input form can optionally display a user requested email. For example, a user can select an email to view in Microsoft Outlook. Responsive to the user selection, Outlook can open the selected email for display to the user. In this example, the selected email call be displayed in a display email window provided by Outlook.

In 302, the modified input form can test whether the user has indicated at desire to compose a new email. Outlook supports functionality to compose a new email in response to a received email or from scratch. For example, the user can reply to a received email, such as the email displayed in the display email window in 300. Alternatively, the user can compose a new email.

If the user desires to compose an email, the modified input form proceeds to 304. If the user does not desire to compose an email, the modified input form remains at 302.

In 304, the modified input form can display a compose window to the user. The compose window can be an input form modified from a preexisting input form. As discussed above, the compose window can be an Outlook form template including a text input field and programmer-defined functionality to capture user inputs in the text input field. The compose window can be configured to appear similar to the preexisting input form or the original compose window.

In 306, the modified input form can test whether a user input is received in the text input field of the compose window. Detection and test functionality for an Outlook form template is available through standard Outlook API. For example, user input can be a client or matter number or other text inputs.

If user input is received, the modified input form proceeds to 308. If no input is received, the modified input form remains at 306.

In 308, the modified input form can test whether programmer-defined behavior has been detected. In the original compose window, any user input that moves a focus from the text input field other than a TAB or ENTER will result in user input loss. For example, the user first enters user input into the text input field, then proceeds to click on the to: or cc: input field to input additional email addresses. In this case, any user input already inputted into the text input field will be lost. Similarly, if the user clicks on another window executing in the Windows desktop, user input will be lost.

Thus, it is necessary for the modified input form to intercept any user behavior other than continued user input into the text input field and a TAB or ENTER. Such user behavior will cause the loss of any user input already inputted into the text input field.

If the programmer-defined behavior has been detected, the modified input form proceeds to 310. If no programmer-defined behavior has been detected, the modified input form returns to 306 to await further user input.

In 310, the modified input form can save the user input in the text input field before processing the intercepted user behavior. For example, the user input already inputted into the text input field can be saved in accessible memory for later retrieval. The user behavior can then be processed.

In 312, the modified input form can optionally test whether a user request to transmit an email has been received. For example, the user can click on a “send” button in the compose window after a draft email has been inputted. The draft email can include a to: address, a subject line, and an email body.

If a user request to transmit the email has been received, the modified input form can proceed to 314. If no user request is received, the modified input form can remain in 312.

In 314, the modified input form can transmit the draft email. The draft email can be transmitted by the modified input form if appropriate functionality is provided in the Outlook form template.

In an alternative, the draft email can be transmitted to Outlook via the Outlook API for transmission. In this example, the registry entry can be restored to the original compose window to load the original compose window. The compose window is then provided with the draft email, including recipient, subject, and body information. After the draft email is transmitted, the registry entry is again modified to point to the modified input form.

In 316, the modified input form can exit the procedure.

It will be appreciated that the above can be implemented in conjunction with a billing module for automatically capturing user time spent on reading and composing emails, as discussed in related applications.

It will be appreciated that the Outlook plug-in as discussed above can provide any number of programmer-specified or user-specified functionality. For example, the plug-in can link to specified content, Uniform Resource Locator (URL) links, text links, various input fields, etc.

As discussed above, one example embodiment of the present invention can be a method for retaining user-inputted text values. The method includes, responsive to a user command to compose an email in an email client, opening a compose window including a first text input field, wherein the compose window includes a programmer-defined behavior for the first text input field to save a first text input field value. The method includes receiving a user input in the first text input field. The method includes, responsive to detecting the programmer-defined behavior, saving the user input from the first text input field into an accessible memory. The modified compose window form can include a second text input field. The first text input field can be a combination box for receiving a client code. The second text input field can be a combination box for receiving a matter code. The programmer-defined behavior can be a mouse click. The email client can be Microsoft Outlook. The compose window can be an Outlook form template. The method includes receiving a draft email in the compose window. The method includes, responsive to a user request to send the draft email, communicating the draft email to the email client for transmission. The method includes receiving a draft email in the compose window. The method includes, responsive to a user request to send the draft email, transmitting the draft email to an email recipient. The method includes, responsive to a user command to view an email, opening an email view window displaying the email. The method includes starting a timer when the email view window can be opened. The method includes pausing the timer when the email view window can be inactive. The method includes stopping the timer when the email view window can be closed.

Another example embodiment of the present invention can be a method for retaining user-inputted text values. The method includes, responsive to a user command, opening an input window including a text input field, wherein the input window includes a programmer-defined behavior for the text input field to save a text input field value. The method includes, receiving a user input in the text input field. The method includes, responsive to detecting the programmer-defined behavior, saving the user input from the text input field into an accessible memory.

Another example embodiment of the present invention can be a system for retaining user-inputted text values. The system includes a processor. The processor can be configured to, responsive to a user command to compose an email in an email client open a compose window including a first text input field, wherein the compose window includes a programmer-defined behavior for the first text input field to save a first text input field value. The processor can be configured to receive a user input in the first text input field. The processor can be configured to, responsive to detecting the programmer-defined behavior save the user input from the first text input field into an accessible memory. The modified compose window form can include a second text input field. The first text input field can be a combination box for receiving a client code. The second text input field can be a combination box for receiving a matter code. The programmer-defined behavior can be a mouse click. The email client can be Microsoft Outlook. The compose window can be an Outlook form template. The processor can be configured to receive a draft email in the compose window. The processor can be configured to, responsive to a user request to send the draft email, communicate the draft email to the email client for transmission. The processor can be configured to receive a draft email in the compose window. The processor can be configured to, responsive to a user request to send the draft email, transmit the draft email to an email recipient. The processor can be configured to, responsive to a user command to view an email, open an email view window displaying the email. The processor can be configured to start a timer when the email view window can be opened. The processor can be configured to pause the timer when the email view window can be inactive. The processor can be configured to stop the timer when the email view window can be closed.

Although the above embodiments have been discussed with reference to specific example embodiments, it will be evident that the various modification, combinations and changes can be made to these embodiments. Accordingly, the specification and drawings are to be regarded in an illustrative sense rather than in a restrictive sense. The foregoing specification provides a description with reference to specific exemplary embodiments. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method for retaining user-inputted text values, comprising:
responsive to a user command to compose an email in an email client, opening a compose window including a first text input field, wherein the compose window includes a programmer-defined behavior for the first text input field to save a first text input field value;
receiving a user input in the first text input field; and
responsive to detecting the programmer-defined behavior, saving the user input from the first text input field into an accessible memory.

2. The method of claim 1, wherein
the modified compose window form includes a second text input field,
the first text input field is a combination box for receiving a client code, and
the second text input field is a combination box for receiving a matter code.

3. The method of claim 1, wherein the programmer-defined behavior is a mouse click.

4. The method of claim 1, wherein the email client is Microsoft Outlook.

5. The method of claim 4, wherein the compose window is an Outlook form template.

6. The method of claim 1, further comprising:
receiving a draft email in the compose window; and
responsive to a user request to send the draft email, communicating the draft email to the email client for transmission.

7. The method of claim 1, further comprising:
receiving a draft email in the compose window;
responsive to a user request to send the draft email, transmitting the draft email to an email recipient.

8. The method of claim 1, further comprising:
responsive to a user command to view an email, opening an email view window displaying the email.

9. The method of claim 8, further comprising:
starting a timer when the email view window is opened.

10. The method of claim 9, further comprising:
pausing the timer when the email view window is inactive.

11. The method of claim 9, further comprising:
stopping the timer when the email view window is closed.

12. A method for retaining user-inputted text values, comprising:
responsive to a user command, opening an input window including a text input field, wherein the input window includes a programmer-defined behavior for the text input field to save a text input field value;
receiving a user input in the text input field; and
responsive to detecting the programmer-defined behavior, saving the user input from the text input field into an accessible memory.

13. A system for retaining user-inputted text values, comprising:
a processor, the processor configured to:
responsive to a user command to compose an email in an email client, open a compose window including a first text input field, wherein the compose window includes a programmer-defined behavior for the first text input field to save a first text input field value;
receive a user input in the first text input field; and
responsive to detecting the programmer-defined behavior, save the user input from the first text input field into an accessible memory.

14. The system of claim 13, wherein
the modified compose window form includes a second text input field,
the first text input field is a combination box for receiving a client code, and
the second text input field is a combination box for receiving a matter code.

15. The system of claim 13, wherein the programmer-defined behavior is a mouse click.

16. The system of claim 13, wherein the email client is Microsoft Outlook.

17. The system of claim 16, wherein the compose window is an Outlook form template.

18. The system of claim 13, the processor further configured to:
receive a draft email in the compose window; and
responsive to a user request to send the draft email, communicate the draft email to the email client for transmission.

19. The system of claim 13, the processor further configured to:
receive a draft email in the compose window;
responsive to a user request to send the draft email, transmit the draft email to an email recipient.

20. The system of claim 13, the processor further configured to:
responsive to a user command to view an email, open an email view window displaying the email.

21. The system of claim 20, the processor further configured to:
start a timer when the email view window is opened.

22. The system of claim 21, the processor further configured to:
pause the timer when the email view window is inactive.

23. The system of claim 21, the processor further configured to:
stop the timer when the email view window is closed.
